(19) United States
(12) Patent Application Publication
(10) Pub. No.: US 2024/0311535 A1
(43) Pub. Date: Sep. 19, 2024

(54) HYDRODYNAMIC FREE-SURFACE LATTICE BOLTZMANN SIMULATION METHOD AND SYSTEM, AND STORAGE MEDIUM

(71) Applicants: CHONGQING XIKE CONSULTING CO.,LTD FOR WATER TRANSPORT ENGINEERING, Chongqing City (CN); CHONGQING JIAOTONG UNIVERSITY, Chongqing City (CN)

(72) Inventors: Peiyi PENG, Chongqing City (CN); Wei DIAO, Chongqing City (CN); Qin ZHOU, Chongqing City (CN); Chunze ZHANG, Chongqing City (CN); Ji HOU, Chongqing City (CN); Bing XING, Chongqing City (CN)

(73) Assignees: CHONGQING XIKE CONSULTING CO.,LTD FOR WATER TRANSPORT ENGINEERING, Chongqing City (CN); CHONGQING JIAOTONG UNIVERSITY, Chongqing City (CN)

(21) Appl. No.: 18/432,047

(22) Filed: Feb. 4, 2024

(30) Foreign Application Priority Data
Mar. 15, 2023 (CN) 2023102533207

(51) Int. Cl. G06F 30/28; G06F 111/10; G06F 113/08; G06F 119/14

(52) U.S. Cl. CPC G06F 30/28; G06F 2111/10; G06F 2113/08; G06F 2119/14

(57) ABSTRACT

The invention introduces a hydrodynamic free-surface Lattice Boltzmann (LB) simulation method and system, along with a storage medium. Initial parameters for a designated water body are obtained and fed into a pre-established three-dimensional hydrodynamic free-surface LB model for simulation calculations. The outcome includes precise data on the free water surface, flow velocity, and pressure of the target water body over time and space, generating a detailed three-dimensional spatial distribution map. The method enhances the second-order accuracy of the force term within the single-phase free-surface LB model. By integrating the single-phase free-surface LB model with surface tension and the SGS large eddy model, it achieves an efficient and accurate three-dimensional simulation of the target water body's free water surface, flow field, and pressure. The approach boasts a straightforward algorithm, robust expandability, excellent parallelism, and easy handling of boundary conditions, distinguishing it from conventional models.

### TECHNICAL FIELD

The present invention relates to the technical field of fluid simulation, and in particular to a hydrodynamic free-surface Lattice Boltzmann (LB) simulation method and system, and a storage medium.

### BACKGROUND ART

The phenomenon of water flow with a free water surface is most common in water conservancy projects. The actual reservoirs have formed a huge water surface, and the water surface shape will change with the fluctuation of water level. The water surface temperature of the reservoir changes due to the long-term atmospheric and solar radiation, and the change of water surface will also affect the distribution of water temperature in the reservoir. The change in water temperature distribution will affect the physical properties of reservoir water, and then affect the water quality environment and ecological environment. Therefore, it is an important scientific basis to optimize the design of the water conservancy project and the operation mode of the reservoir and reduce the ecological side effects caused by water quality and temperature change to simulate the flow field in the reservoir region with water surface efficiently and accurately.

The conventional method for simulating the reservoir flow field is to solve the gas phase and liquid phase of the reservoir region through a two-phase flow model to obtain the movement state of the interface (namely, the water surface). The actual reservoir is not only huge in spatial scale but also has a complex geometric shape. If the two-phase flow model is used for simulation calculation, the number of grids needed to be consumed is very large. The traditional two-phase flow model calculates and stores the gas phase fluid and the liquid phase fluid at the same time, involving complex gradient calculation, and the computer resource consumption is very high under a large number of calculation grids. The two-phase flow model has no obvious advantage in simulating the surface movement of a reservoir. LB method is a newly developed hydrodynamic numerical simulation theory, which has been widely used in many fields, such as multiphase flow, heat and mass transfer flow, interface dynamics, chemical reaction and combustion, fluid-solid coupling, seepage, and so on. However, its development and application in the related fields of reservoirs are rare.

The single-phase free-surface model based on the LB method is mainly used in the metallurgical industry to simulate the casting and forming process of liquid metal to optimize the production of metal components. The assumption of the model cannot be fully applied to the large-scale flow movement of reservoirs. In the casting of small-scale metal components, the effect of viscous force on metal forming is much greater than that of gravity. Therefore, the original model only adopts the first-order force term based on a lattice gas automaton (LGA), which has low accuracy and satisfies the conservation of the first-order continuity equation but does not satisfy the conservation of the second-order momentum equation. A considerable part of the hydraulic problems is gravity-driven, such as dam breaks and flood discharge. The inaccuracy of gravity calculation will directly affect the simulation accuracy of water flow movement. Since the original model is used to fill the metal of the closed mold, the surface tension effect is not particularly considered. Surface tension plays an important role in water body shaping in water conservancy projects, such as the contraction of the water tongue and the break and fusion of water flowers. In addition, the original model is applied to the metal casting process with a small scale and small Reynolds number, while the actual reservoir size is huge, the flow structure is complex, and most of the water movement is turbulent. Therefore, an efficient and accurate simulation model and corresponding simulation method for the reservoir flow field are urgently needed.

### SUMMARY

An object of the present invention is to provide a hydrodynamic free-surface LB simulation method and system, and a storage medium for solving the above-mentioned problems in the prior art.

To achieve the above object, the present invention adopts the following technical solutions:

In a first aspect, there is provided a hydrodynamic free-surface LB simulation method, including:
acquiring initial parameters for a target water body;
importing the initial parameters into a pre-set three-dimensional hydrodynamic free-surface LB model for simulation calculation to obtain free water surface data, flow velocity data, and pressure data of the target water body based on time and space, where the three-dimensional hydrodynamic free-surface LB model improves a first-order force term into a modified second-order moment model based on a single-phase free-surface LB model and introduces a surface tension model and a large eddy model; and
obtaining distribution results of a free water surface, a flow velocity, and a pressure of the target water body according to the free water surface data, flow velocity data, and pressure data of the target water body based on time and space.

In one possible design, the three-dimensional hydrodynamic free-surface LB model includes the modified second-order moment model, the surface tension model, and the large eddy model, the modified second-order moment model being

$${f}_{a} ( x + {e}_{α} {δ}_{t} , t + {δ}_{t} ) - {f}_{α} ( x , t ) = Ω + {δ}_{t} {F}_{α} , \\ {F}_{α} = ( 1 - \frac{1}{2 τ} ) {ω}_{α} ( \frac{{e}_{α} - u}{{c}_{s}^{2}} + \frac{{e}_{α} \cdot u}{{c}_{s}^{4}} \cdot {e}_{α} ) \cdot f , \\ ρ = {\sum }_{α} {f}_{α} , ρ u = {\sum }_{α} {e}_{α} {f}_{α} + \frac{1}{2} f {δ}_{t} ,$$

where F represents a force term function; f represents a free water surface distribution function; x represents a vector position parameter; α represents a direction parameter; Ω represents a collision operator parameter; cₛ represents a lattice velocity; δₜ represents a unit time parameter; t is a time parameter; u represents a water flow velocity parameter; ω represents a calculation weight coefficient; τ represents a relaxation time parameter; e represents a format velocity parameter; and ρ represents a water body density parameter.

The surface tension model is

$${f}_{inv ( i )} ( x , t + Δ t ) = {f}_{i}^{eq} ( {ρ}_{G} , u ) + {f}_{inv ( i )}^{eq} ( {ρ}_{G} , u ) - {f}_{i} ( x , t ) + Δ {f}_{i} , \\ Δ {f}_{i} = β \vert \frac{\partial m}{\partial n} \vert cos 2 ( {θ}_{i} - {θ}_{n} ) ,$$

where fᵢₙᵥ represents an inverse distribution function; fᵢₙᵥ^{eq} represents an inverse equilibrium distribution function; f^{eq} represents a forward equilibrium distribution function; ρ_{G} represents an atmospheric pressure at an interface; β represents a surface tension coefficient; n represents an interface normal direction; θᵢ represents an angle in a lattice direction; i represents the lattice direction; θₙ represents an angle of a mass gradient; and ∂m/∂n represents a gradient of mass along the interface normal direction.

The large eddy model is

$${\overline{f}}_{i} ( x + c {δ}_{t} , t + {δ}_{t} ) = {\overline{f}}_{i} ( x , t ) - \frac{1}{{τ}_{e}} [ {\overline{f}}_{i} ( x , t ) - {f}_{i}^{eq} ( ρ , u ) ] + {δ}_{t} {F}_{i} ,$$

where ƒ̅ represents a flow field distribution function; c represents a unit velocity parameter; and τₑ represents an effective relaxation time.

In one possible design, the initial parameters include the collision operator parameter, the water flow velocity parameter, the relaxation time parameter, the effective relaxation time, the format velocity parameter, the water body density parameter, the calculation weight coefficient, and the surface tension coefficient.

In one possible design, the obtaining distribution results of a free water surface, a flow velocity, and a pressure of the target water body according to the free water surface data, flow velocity data, and pressure data of the target water body based on time and space includes: constructing a three-dimensional spatial distribution map of the free water surface, flow velocity, and pressure of the target water body according to the free water surface data, flow velocity data, and pressure data of the target water body based on time and space.

In one possible design, the constructing a three-dimensional spatial distribution map of the free water surface, flow velocity, and pressure of the target water body according to the free water surface data, flow velocity data, and pressure data of the target water body based on time and space includes: importing the free water surface data, flow velocity data, and pressure data of the target water body based on time and space into a preset Tecplot software to construct the three-dimensional spatial distribution map of the free water surface, flow velocity, and pressure of the target water body.

In one possible design, the method further includes: acquiring a construction instruction, constructing the three-dimensional hydrodynamic free-surface LB model according to the construction instruction, and pre-storing the three-dimensional hydrodynamic free-surface LB model.

In a second aspect, a hydrodynamic free-surface LB simulation system is provided, including an acquisition unit, a simulation unit, and an output unit.

The acquisition unit is configured to acquire initial parameters for a target water body.

The simulation unit is configured to import the initial parameters into a pre-set three-dimensional hydrodynamic free-surface LB model for simulation calculation to obtain free water surface data, flow velocity data, and pressure data of the target water body based on time and space; the three-dimensional hydrodynamic free-surface LB model improves a first-order force term into a modified second-order moment model based on a single-phase free-surface LB model and introduces a surface tension model and a large eddy model.

The output unit is configured to obtain distribution results of a free water surface, a flow velocity, and a pressure of the target water body according to the free water surface data, flow velocity data, and pressure data of the target water body based on time and space.

In one possible design, the system further includes a construction unit; the construction unit is configured to acquire construction instruction, construct the three-dimensional in hydrodynamic free-surface LB model according to the construction instruction, and pre-store the three-dimensional hydrodynamic free-surface LB model.

In a third aspect, there is provided a hydrodynamic free-surface LB simulation system, including:

A memory is configured to store instructions.

A processor is configured to read the instructions stored in the memory and perform the method according to any one of the first aspects according to the instructions.

In a fourth aspect, there is provided a computer-readable storage medium storing thereon instructions, the instructions, when executed on a computer, causing the computer to perform the method according to any one of the first aspects. There is further provided a computer program product including instructions, the instructions, when executed on a computer, causing the computer to perform the method according to any one of the first aspects.

Beneficial effects: the present invention, initial parameters for a target water body are acquired, and the initial parameters are imported into a pre-set three-dimensional hydrodynamic free-surface LB model for simulation calculation to obtain free water surface data, flow velocity data, and pressure data of the target water body based on time and space, and accurately depict and output a three-dimensional spatial distribution map of a free water surface, flow velocity, and pressure of the target water body. The present invention is based on the single-phase free-surface LB model, improves the second-order accuracy of the force term and combines the single-phase free-surface LB model with the surface tension model and the SGS large eddy model to achieve an efficient and accurate three-dimensional simulation of the free water surface, flow field and pressure of the target water body, which has the advantages of simple algorithm, strong expansibility, good parallelism and easy handling of boundary conditions compared with the conventional model.

### BRIEF DESCRIPTION OF THE DRAWINGS

To explain the examples of the present disclosure or the technical solutions in the prior art more clearly, a brief introduction will be made to the accompanying drawings used in the examples or the description of the prior art. It is obvious that the drawings in the description below are only some examples of the present disclosure, and those ordinarily skilled in the art can obtain other drawings according to these drawings without creative work.

FIG. 1 is a diagram of steps of a method according to an example of the present invention;

FIG. 2 is a diagram of a dam break water column experiment according to an example of the present invention; FIG. 2(a) is a diagram of an experimental device, and FIG. 2(b) is a diagram of a structural simulation;

FIG. 3 is an experimental result diagram of a dam break water column according to an example of the present invention; FIG. 3(a) is an actual experimental result diagram, and FIG. 3(b) is a simulation diagram of the experimental result;

FIG. 4 is a water surface and flow velocity distribution map of dam break surge simulated by the method; FIG. 4(a) is a water surface and flow velocity distribution map at 0.12 s, and FIG. 4(b) is a water surface and flow velocity distribution map at 0.3 s;

FIG. 5 is a composition diagram of a system according to an example of the present invention.

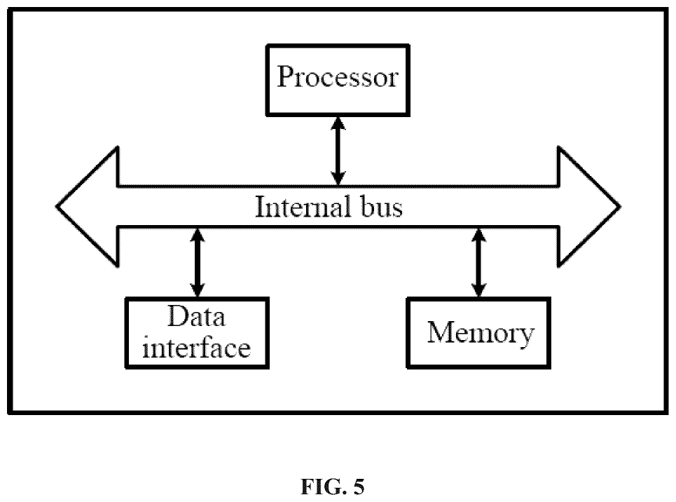

### DETAILED DESCRIPTION OF THE EMBODIMENTS

It is to be understood that the description of these examples is intended to aid in the understanding of the present invention, and is not intended to limit the scope of the present invention. The specific structural and functional details disclosed herein are merely illustrative of exemplary examples of the present invention. The present invention may, however, be embodied in many alternative forms and should not be construed as limited to the examples set forth herein.

It is to be understood that, unless expressly specified and limited otherwise, the term “connected” is to be interpreted broadly, e.g. either fixedly or detachably, or integrally; maybe a mechanical connection or an electrical connection; it can be directly connected or indirectly connected through an intermediate medium, and can be the communication between two elements. The specific meaning of the above terms in the examples can be understood by those of ordinary skill in the art according to specific circumstances.

In the following description, specific details are provided to facilitate a thorough understanding of example examples. However, it will be understood by one of ordinary skill in the art that the example examples may be practiced without these specific details. For example, systems may be shown in block diagrams in order not to obscure the examples in unnecessary detail. In other instances, well-known processes, structures, and techniques may not be shown in unnecessary detail to avoid obscuring the examples.

### Example 1

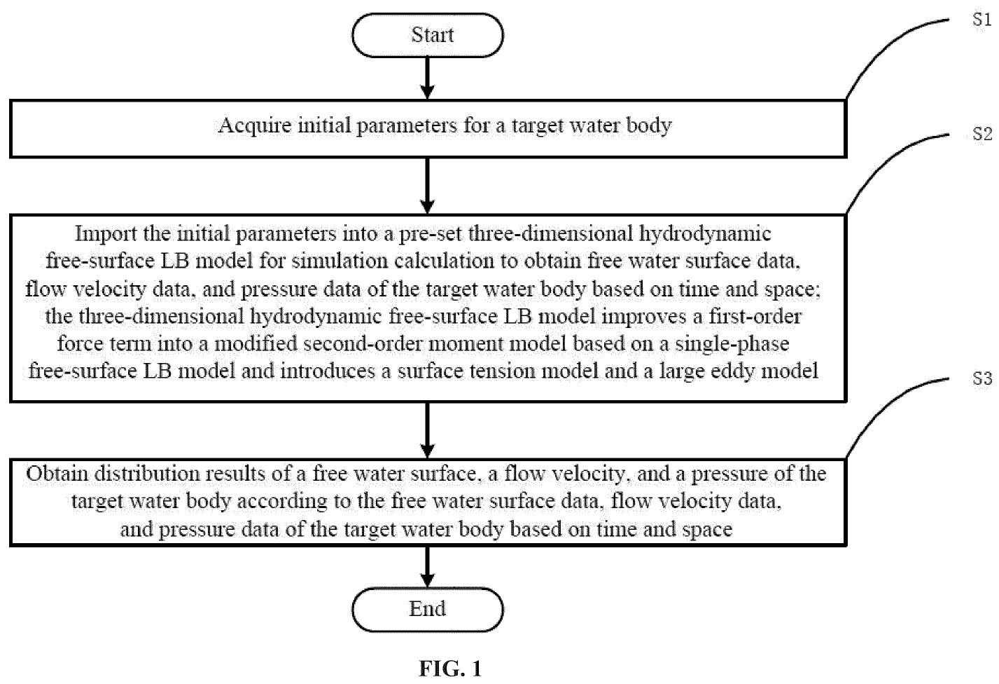

The example provides a hydrodynamic free-surface LB simulation method, as shown in FIG. 1, including the following steps:
S1: Acquire initial parameters for a target water body.

In a specific implementation, before performing a simulation, it is necessary to obtain initial parameters for a target water body first; the initial parameters include the collision operator parameter, the water flow velocity parameter, the relaxation time parameter, the effective relaxation time, the format velocity parameter, the water body density parameter, the calculation weight coefficient, and the surface tension coefficient.
S2: Import the initial parameters into a pre-set three-dimensional hydrodynamic free-surface LB model for simulation calculation to obtain free water surface data, flow velocity data, and pressure data of the target water body based on time and space; the three-dimensional hydrodynamic free-surface LB model improves a first-order force term into a modified second-order moment model based on a single-phase free-surface LB model and introduces a surface tension model and a large eddy model.

In the specific implementation, after obtaining the initial parameters, the initial parameters are imported into a preset three-dimensional hydrodynamic free-surface LB model for simulation calculation, to obtain free water surface data, flow velocity data, and pressure data of the target water body based on time and space; the three-dimensional hydrodynamic free-surface LB model improves the first-order force term into a modified second-order moment model based on a single-phase free-surface LB model and introduces a surface tension model and a large eddy model. The construction process of the three-dimensional hydrodynamic free-surface LB model includes: acquiring a construction instruction, constructing the three-dimensional hydrodynamic free-surface LB model according to the construction instructions, and pre-storing the three-dimensional hydrodynamic free-surface LB model. The three-dimensional hydrodynamic free-surface LB model includes a modified second-order moment model, a surface tension model, and a large eddy model; the first-order force term in the original single-phase free-surface LB model is modified into a modified second-order moment model, and the original model is

$${f}_{α} ( x + {e}_{α} {δ}_{t} , t + {δ}_{t} ) - {f}_{i} ( x , t ) = - \frac{1}{τ} [ {f}_{α} ( x , t ) - {f}_{α}^{( eq )} ( x , t ) ] + {δ}_{t} {F}_{α} .$$

The modified second-order moment model is

$${f}_{α} ( x + {e}_{α} {δ}_{t} , t + {δ}_{t} ) - {f}_{α} ( x , t ) = Ω + {δ}_{t} {F}_{α} , \\ {F}_{α} = ( 1 - \frac{1}{2 τ} ) {ω}_{α} ( \frac{{e}_{α} - u}{{c}_{s}^{2}} + \frac{{e}_{α} \cdot u}{{c}_{s}^{4}} \cdot {e}_{α} ) \cdot f .$$

To eliminate the discretization error caused by the force in the mass equation and the pseudo-velocity caused by the momentum equation, the statistical formula of the macroscopic physical quantity needs to be modified as follows:

$$ρ = {\sum }_{α} {f}_{α} , ρ u = {\sum }_{α} {e}_{α} {f}_{α} + \frac{1}{2} f {δ}_{t} ,$$

where F represents a force term function; f represents a free water surface distribution function; x represents a vector position parameter; α represents a direction parameter; Ω represents a collision operator parameter; cₛ represents a lattice velocity; δₜ represents a unit time parameter; t is a time parameter; u represents a water flow velocity parameter; ω represents a calculation weight coefficient; τ represents a relaxation time parameter; e represents a format velocity parameter; and ρ represents a water body density parameter.

The surface tension is introduced by adding a disturbance term to the improved model in the process of interface lattice reconstruction. The improved surface tension model is as follows:

$${f}_{inv ( i )} ( x , t + Δ t ) = {f}_{i}^{eq} ( {ρ}_{G} , u ) + {f}_{inv ( i )}^{eq} ( {ρ}_{G} , u ) - {f}_{i} ( x , t ) + Δ {f}_{i} .$$

Δfᵢ is defined as

$$Δ {f}_{i} = β \vert \frac{\partial m}{\partial n} \vert cos 2 ( {θ}_{i} - {θ}_{n} ) ,$$

where fᵢₙᵥ represents an inverse distribution function; fᵢₙᵥ^{eq} represents an inverse equilibrium distribution function; f^{eq} represents a forward equilibrium distribution function; ρ_{G} represents an atmospheric pressure at an interface; β represents a surface tension coefficient; n represents an interface normal direction; θᵢ represents an angle in a lattice direction; i represents the lattice direction; θₙ represents an angle of a mass gradient; and ∂m/∂n represents a gradient of mass along the interface normal direction. A perturbation term is added to the rebound scheme of the boundary to simulate the wettability of the solid wall:

$${f}_{inv ( i )} ( x , t ) = {f}_{i} ( x , t ) + Δ {f}_{i}^{w} ( x , t ) .$$

The evolution equation of the simulated flow is:

$${f}_{i} ( x + {c}_{i} {δ}_{t} , t + {δ}_{t} ) - {f}_{i} ( x , t ) = - \frac{1}{τ} [ {f}_{i} ( x , t ) - {f}_{i}^{( eq )} ( x , t ) ] .$$

The large eddy model is introduced by decomposing the physical quantities of the improved model into large-scale quantities and small-scale quantities, such as Φ=Φ̅+Φ′, where Φ̅ is a large-scale quantity, and Φ′ is a small-scale quantity, which can be obtained by Φ filtering:

ϕ̅=∫ϕ(x′,t)G(x,x′)dx′,
where G is a filtering function, and a small-scale quantity Φ′ can be obtained by making a difference: Φ′=Φ−Φ̅. The evolution equation is filtered and assumed

\sqrt{ƒᵢ^{eq}(ρ,u)}=ƒᵢ^{eq}(ρ̅,ū)

The effective relaxation time τₑ is calculated from the effective viscosity vₑ: vₑ=v+vₜ=cₛ²(τₑ−0.5), where vi is the eddy viscosity; and vₜ=(CΔ)²|S|, where C, Δ, and S represent the model parameters, the filter width, and the strain rate tensor.

Therefore, the large eddy model is

$${\overline{f}}_{i} ( x + c {δ}_{t} , t + {δ}_{t} ) = {\overline{f}}_{i} ( x , t ) - \frac{1}{{τ}_{e}} [ {\overline{f}}_{i} ( x , t ) - {f}_{i}^{eq} ( ρ , u ) ] + {δ}_{t} {F}_{t} ,$$

where ƒ̅ represents a flow field distribution function; c represents a unit velocity parameter; and τₑ represents an effective relaxation time.
S3: Obtain distribution results of a free water surface, a flow velocity, and a pressure of the target water body according to the free water surface data, flow velocity data, and pressure data of the target water body based on time and space.

In the specific implementation, after the free water surface data, flow velocity data, and corresponding pressure data of the target water body based on time and space are simulated, the free water surface data, flow velocity data, and corresponding pressure data can be imported into the preset Tecplot software to construct the three-dimensional spatial distribution map of the free water surface, flow velocity and pressure of the target water body as the spatial distribution for output, to realize the accurate three-dimensional simulation characterization of the free water surface, flow field and pressure of the target water body.

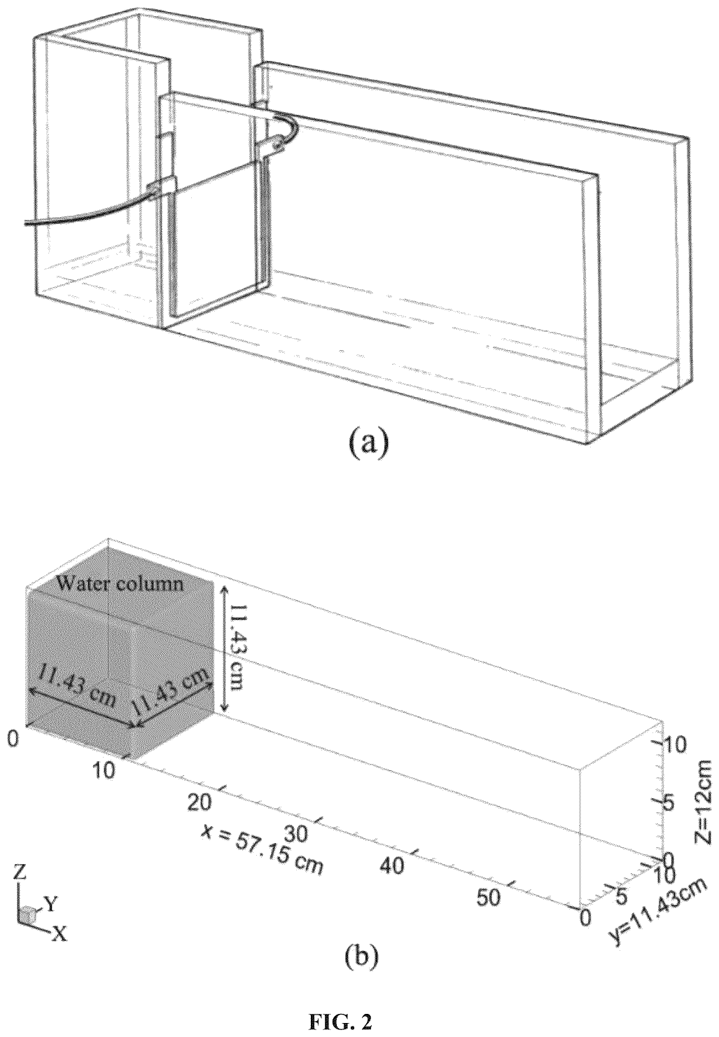

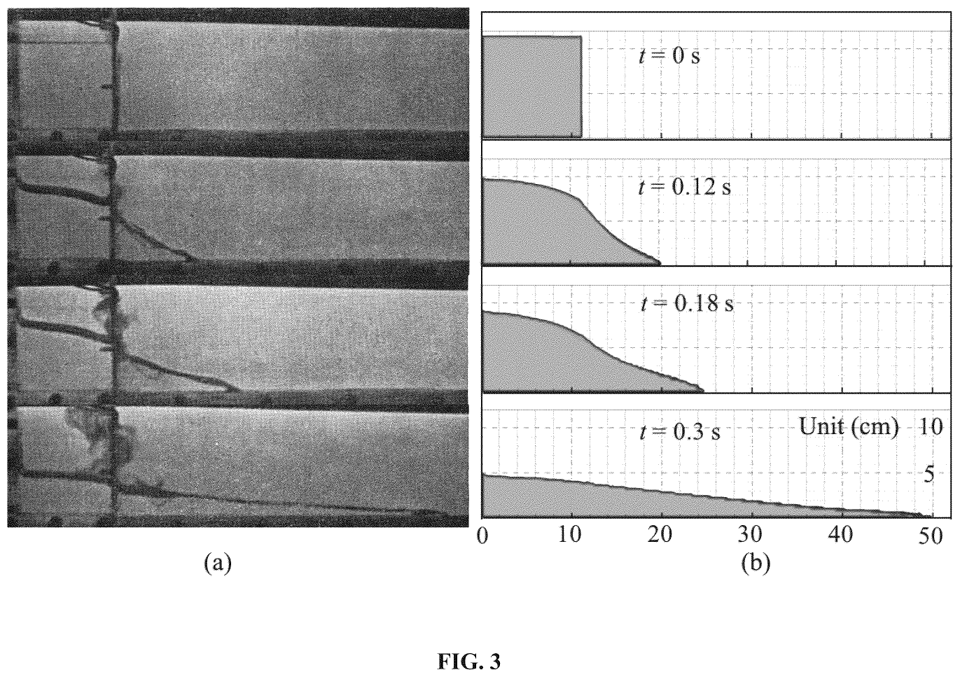

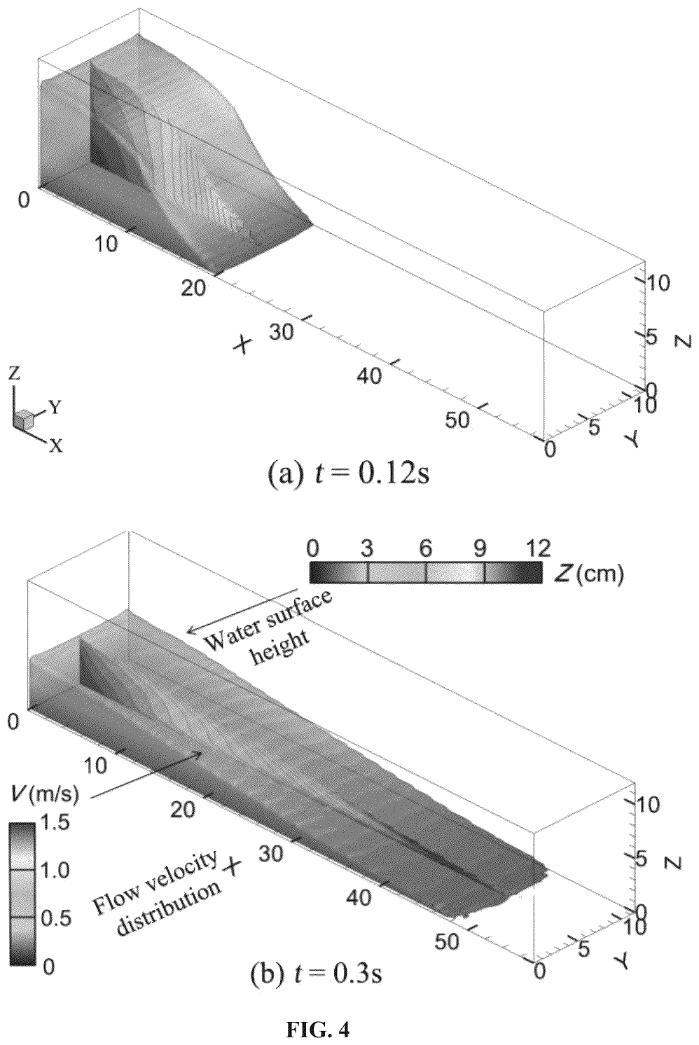

Concerning the above-mentioned method, the present example provides a specific application example: as shown in FIG. 2, the channel with 57.15 cm in length, 11.43 cm in width, and 12 cm in height is simulated by the corresponding full dam-break water column experimental device. The initial water column is a cube with sides of 11.43 cm. After the start of the experiment, the gate suddenly opens, and the water column immediately collapses and breaks the dam. The data of the change of the water column top height and surge propagation distance with time are recorded in real-time, and the corresponding experimental results are obtained, as shown in FIG. 3. The simulated grid scale is Δx=0.198 cm, the number is 288×58×96. Each boundary of the calculation region is a water tank wall surface and is set as a non-slip solid wall. The dimension parameters, grid-scale, and other parameters of the experimental device are input into the three-dimensional hydrodynamic free-surface LB model, then the simulation is run, and the output results are sorted out to obtain the water surface and flow velocity distribution map of the dam break surge wave and the dam break surge wave as shown in FIG. 4. By comparing the corresponding experimental results, it can be seen that the method can realize the accurate simulation description of the free water surface and flow.

### Example 2

The present example provides a hydrodynamic free-surface LB simulation system, including an acquisition unit, a simulation unit, and an output unit.

The acquisition unit is configured to acquire initial parameters for a target water body.

The simulation unit is configured to import the initial parameters into a pre-set three-dimensional hydrodynamic free-surface LB model for simulation calculation to obtain free water surface data, flow velocity data, and pressure data of the target water body based on time and space; the three-dimensional hydrodynamic free-surface LB model improves a first-order force term into a modified second-order moment model based on a single-phase free-surface LB model and introduces a surface tension model and a large eddy model.

The output unit is configured to obtain distribution results of a free water surface, a flow velocity, and a pressure of the target water body according to the free water surface data, flow velocity data, and pressure data of the target water body based on time and space.

Further, the system includes a construction unit; the construction unit is configured to acquire a construction instruction, construct a multi-field coupled LB model of heat and mass transfer flow according to the construction instruction, and pre-store the multi-field coupled LB model.

### Example 3

The example provides a hydrodynamic free-surface LB simulation system, as shown in FIG. 4, including, at the hardware level:

A data interface is configured to establish data docking between the processor and the data source end.

A memory is configured to store instructions.

A processor is configured to read an instruction stored in the memory, and execute the hydrodynamic free-surface LB simulation method in Example 1 according to the instruction: S1, acquiring initial parameters for a target water body; S2, importing the initial parameters into a pre-set three-dimensional hydrodynamic free-surface LB model for simulation calculation to obtain free water surface data, flow velocity data, and pressure data of the target water body based on time and space; the three-dimensional hydrodynamic free-surface LB model improves a first-order force term into a modified second-order moment model based on a single-phase free-surface LB model and introduces a surface tension model and a large eddy model; S3, obtaining distribution results of a free water surface, a flow velocity, and a pressure of the target water body according to the free water surface data, flow velocity data, and pressure data of the target water body based on time and space.

Optionally, the device further includes an internal bus. The processor and memory and data interfaces may be interconnected by an internal bus, which may be an industry standard architecture (ISA) bus, a peripheral component interconnect (PCI) bus, or an extended industry standard architecture (EISA) bus. The bus may be divided into an address bus, a data bus, a control bus, and the like.

The memory may include, but is not limited to, random access memory (RAM), read-only memory (ROM), flash memory, first input first output (FIFO), and/or first in last out (FILO), and the like. The processor may be a general-purpose processor, including a central processing unit (CPU), a network processor (NP), and the like; they may also be digital signal processors (DSP), application-specific integrated circuit (ASIC), field-programmable gate arrays (FPGA), or other programmable logic devices, discrete gate, or transistor logic devices, discrete hardware components.

### Example 4

The example provides a computer-readable storage medium storing thereon instructions, the instructions, when executed on a computer, causing the computer to perform the hydrodynamic free-surface LB simulation method in Example 1: S1, acquiring initial parameters for a target water body; S2, importing the initial parameters into a pre-set three-dimensional hydrodynamic free-surface LB model for simulation calculation to obtain free water surface data, flow velocity data, and pressure data of the target water body based on time and space; the three-dimensional hydrodynamic free-surface LB model improves a first-order force term into a modified second-order moment model based on a single-phase free-surface LB model and introduces a surface tension model and a large eddy model; S3, obtaining distribution results of a free water surface, a flow velocity, and a pressure of the target water body according to the free water surface data, flow velocity data, and pressure data of the target water body based on time and space. The computer readable storage medium refers to the carrier for storing data, which may, but not limited to, include floppy disk, optical disk, hard disk, flash memory, flash drive, and/or memory stick. The computer may be a general-purpose computer, special-purpose computer, computer network, or other programmable system.

The example also provides a computer program product including instructions, the instructions, when executed on a computer, causing the computer to perform the hydrodynamic free-surface LB simulation method in Example 1: S1, acquiring initial parameters for a target water body; S2, importing the initial parameters into a pre-set three-dimensional hydrodynamic free-surface LB model for simulation calculation to obtain free water surface data, flow velocity data, and pressure data of the target water body based on time and space; the three-dimensional hydrodynamic free-surface LB model improves a first-order force term into a modified second-order moment model based on a single-phase free-surface LB model and introduces a surface tension model and a large eddy model; S3, obtaining distribution results of a free water surface, a flow velocity, and a pressure of the target water body according to the free water surface data, flow velocity data, and pressure data of the target water body based on time and space. The computer may be a general-purpose computer, a special-purpose computer, a computer network, or other programmable system.

Finally, it should be noted that: the above description is of preferred examples of the present invention and is not intended to limit the scope of the present invention. Thus, it is intended that the present invention cover the modifications and variations of this invention provided they come within the scope of the appended claims and their equivalents.

What is claimed is:

1. A hydrodynamic free-surface Lattice Boltzmann (LB) simulation method, comprising:
acquiring initial parameters for a target water body;
importing the initial parameters into a pre-set three-dimensional hydrodynamic free-surface LB model for simulation calculation to obtain free water surface data, flow velocity data, and pressure data of the target water body based on time and space, wherein the three-dimensional hydrodynamic free-surface LB model improves a first-order force term into a modified second-order moment model based on a single-phase free-surface LB model and introduces a surface tension model and a large eddy model; and
obtaining distribution results of a free water surface, a flow velocity, and a pressure of the target water body according to the free water surface data, flow velocity data, and pressure data of the target water body based on time and space.

2. The hydrodynamic free-surface LB simulation method according to claim 1, wherein the three-dimensional hydrodynamic free-surface LB model comprises the modified second-order moment model, the surface tension model, and the large eddy model, the modified second-order moment model being
$${f}_{α} ( x + {e}_{α} {δ}_{t} , t + {δ}_{t} ) - {f}_{α} ( x , t ) = Ω + {δ}_{t} {F}_{α} , \\ {F}_{α} = ( 1 - \frac{1}{2 τ} ) {ω}_{α} ( \frac{{e}_{α} - u}{{c}_{s}^{2}} + \frac{{e}_{α} \cdot u}{{c}_{s}^{4}} \cdot {e}_{α} ) \cdot f , \\ ρ = {\sum }_{α} {f}_{α} , ρ u = {\sum }_{α} {e}_{α} {f}_{α} + \frac{1}{2} f {δ}_{t} ,$$
wherein F represents a force term function; f represents a free water surface distribution function; x represents a vector position parameter; α represents a direction parameter; Ω represents a collision operator parameter; cₛ represents a lattice velocity; δₜ represents a unit time parameter; t is a time parameter; u represents a water flow velocity parameter; ω represents a calculation weight coefficient; τ represents a relaxation time parameter; e represents a format velocity parameter; and ρ represents a water body density parameter;
the surface tension model being
$${f}_{inv ( i )} ( x , t + Δ t ) = {f}_{i}^{eq} ( {ρ}_{G} , u ) + {f}_{inv ( i )}^{eq} ( {ρ}_{G} , u ) - {f}_{i} ( x , t ) + Δ {f}_{i} , \\ Δ {f}_{i} = β \vert \frac{\partial m}{\partial n} \vert cos 2 ( {θ}_{i} - {θ}_{n} ) ,$$
wherein fᵢₙᵥ represents an inverse distribution function; fᵢₙᵥ^{eq} represents an inverse equilibrium distribution function; f^{eq} represents a forward equilibrium distribution function; ρ_{G} represents an atmospheric pressure at an interface; β represents a surface tension coefficient; n represents an interface normal direction; θᵢ represents an angle in a lattice direction; i represents the lattice direction; On represents an angle of a mass gradient; and ∂m/∂n represents a gradient of mass along the interface normal direction; and
the large eddy model being
$${\overline{f}}_{i} ( x + c {δ}_{t} , t + {δ}_{t} ) = {\overline{f}}_{i} ( x , t ) - \frac{1}{{τ}_{e}} [ {\overline{f}}_{i} ( x , t ) - {f}_{i}^{eq} ( ρ , u ) ] + {δ}_{t} {F}_{i} ,$$
wherein ƒ̅ represents a flow field distribution function; c represents a unit velocity parameter; and τₑ represents an effective relaxation time.

3. The hydrodynamic free-surface LB simulation method according to claim 2, wherein the initial parameters comprise the collision operator parameter, the water flow velocity parameter, the relaxation time parameter, the effective relaxation time, the format velocity parameter, the water body density parameter, the calculation weight coefficient, and the surface tension coefficient.

4. The hydrodynamic free-surface LB simulation method according to claim 1, wherein the obtaining distribution results of a free water surface, a flow velocity, and a pressure of the target water body according to the free water surface data, flow velocity data, and pressure data of the target water body based on time and space comprises: constructing a three-dimensional spatial distribution map of the free water surface, flow velocity, and pressure of the target water body according to the free water surface data, flow velocity data, and pressure data of the target water body based on time and space.

5. The hydrodynamic free-surface LB simulation method according to claim 4, wherein the constructing a three-dimensional spatial distribution map of the free water surface, flow velocity, and pressure of the target water body according to the free water surface data, flow velocity data, and pressure data of the target water body based on time and space comprises: importing the free water surface data, flow velocity data, and pressure data of the target water body based on time and space into a preset Tecplot software to construct the three-dimensional spatial distribution map of the free water surface, flow velocity, and pressure of the target water body.

6. The hydrodynamic free-surface LB simulation method according to claim 1, further comprising: acquiring a construction instruction, constructing the three-dimensional hydrodynamic free-surface LB model according to the construction instruction, and pre-storing the three-dimensional hydrodynamic free-surface LB model.

7. A hydrodynamic free-surface Lattice Boltzmann (LB) simulation system, comprising an acquisition unit, a simulation unit, and an output unit, wherein
the acquisition unit is configured to acquire initial parameters for a target water body;
the simulation unit is configured to import the initial parameters into a pre-set three-dimensional hydrodynamic free-surface LB model for simulation calculation to obtain free water surface data, flow velocity data, and pressure data of the target water body based on time and space, wherein the three-dimensional hydrodynamic free-surface LB model improves a first-order force term into a modified second-order moment model based on a single-phase free-surface LB model and introduces a surface tension model and a large eddy model; and
the output unit is configured to obtain distribution results of a free water surface, a flow velocity, and a pressure of the target water body according to the free water surface data, flow velocity data, and pressure data of the target water body based on time and space.

8. The hydrodynamic free-surface LB simulation system according to claim 7, further comprising a construction unit, wherein the construction unit is configured to acquire a construction instruction, construct the three-dimensional hydrodynamic free-surface LB model according to the construction instruction, and pre-store the three-dimensional hydrodynamic free-surface LB model.

9. A hydrodynamic free-surface Lattice Boltzmann (LB) simulation system, comprising:
a memory, configured to store instructions; and
a processor, configured to read the instructions stored in the memory and perform the method according to claim 1 according to the instructions.

10. A computer-readable storage medium storing thereon instructions, the instructions, when executed on a computer, causing the computer to perform the method according to claim 1.

11. A hydrodynamic free-surface Lattice Boltzmann (LB) simulation system, comprising:
a memory, configured to store instructions; and
a processor, configured to read the instructions stored in the memory and perform the method according to claim 2 according to the instructions.

12. A hydrodynamic free-surface Lattice Boltzmann (LB) simulation system, comprising:
a memory, configured to store instructions; and
a processor, configured to read the instructions stored in the memory and perform the method according to claim 3 according to the instructions.

13. A hydrodynamic free-surface Lattice Boltzmann (LB) simulation system, comprising:
a memory, configured to store instructions; and
a processor, configured to read the instructions stored in the memory and perform the method according to claim 4 according to the instructions.

14. A hydrodynamic free-surface Lattice Boltzmann (LB) simulation system, comprising:
a memory, configured to store instructions; and
a processor, configured to read the instructions stored in the memory and perform the method according to claim 5 according to the instructions.

15. A hydrodynamic free-surface Lattice Boltzmann (LB) simulation system, comprising:
a memory, configured to store instructions; and
a processor, configured to read the instructions stored in the memory and perform the method according to claim 6 according to the instructions.

16. A computer-readable storage medium storing thereon instructions, the instructions, when executed on a computer, causing the computer to perform the method according to claim 2.

17. A computer-readable storage medium storing thereon instructions, the instructions, when executed on a computer, causing the computer to perform the method according to claim 3.

18. A computer-readable storage medium storing thereon instructions, the instructions, when executed on a computer, causing the computer to perform the method according to claim 4.

19. A computer-readable storage medium storing thereon instructions, the instructions, when executed on a computer, causing the computer to perform the method according to claim 5.

20. A computer-readable storage medium storing thereon instructions, the instructions, when executed on a computer, causing the computer to perform the method according to claim 6.
